(19) United States
(12) Patent Application Publication
(10) Pub. No.: US 2007/0029746 A1
(43) Pub. Date: Feb. 8, 2007

(54) Portable electric workstation

(76) Inventor: Bernard A. Brennan JR., Bogalusa, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/581,531

(22) Filed: Oct. 17, 2006

Related U.S. Application Data
(63) Continuation-in-part of application No. 10/853,937, filed on Dec. 30, 2003.
Application No. 10/853,937 is a continuation of application No. 09/858,774, filed on May 16, 2001, now Pat. No. 6,702,608.

(51) Int. Cl. B62B 1/00

(52) U.S. Cl. 280/47.26

(57) ABSTRACT

An electric workstation in the shape of a hollow cabinet allows bringing electrical power connections to a site remote from a municipal electrical power supply. The cabinet is provided with one or more electrical sockets for connecting of electrically-powered tools and equipment, as well as one or more reels for holding electrical extension cords. The sockets are operationally connected to an on/off switch, and the reels are likewise connected to individual on/off switches. The cabinet rests on the bottom plate when in use and can be transported to the job site with the help of recessed rotating wheels secured in the rear bottom corners of the cabinet. A handle is secured to the rear wall to allow pulling or pushing of the cabinet when required.

### CROSS-REFERENCE TO RELATED APPLICATIONS

This application is a continuation-in-part of my co-pending application Ser. No. 10/853,937 filed on May 26, 2004 for “Electric Work Station with Power Reel Cords,” which is a continuation of my application Ser. No. 09/858,774 filed on May 16, 2001 for “Electric Work Station with Power Reel Cords,” now U.S. Pat. No. 6,702,608, the priority of which is hereby claimed and the full disclosure of which is incorporated by reference herein.

### BACKGROUND OF THE INVENTION

This invention relates to workstations, and more particularly, to a portable workstation that allows an operator to bring electrical connections, in an organized manner, closer to a job site.

Tradesmen and hobbyists have long used various workstations for storing small tools, equipment, supplies and other small items in drawers of a cabinet-like enclosure. These cabinets are usually of small size so that they can be transported easily from one site to another, as the job requires. Some of the workstations provide extendable top work surfaces, on which various drills, saws and other similar equipment can be permanently or detachably secured. Most of such workstations are designed for users working with wood or metal in a garage or a workshop.

Oftentimes, a craftsman or a tradesman requires a source of electrical supply at a location somewhat removed from the house AC power. One example of a work station that allows the user access to electric extension cords is disclosed in my U.S. Pat. No. 6,702,608. Some tests performed with the electric workstation according to the '608 patent showed that it is desirable to have additional electric outlets, compartments and devices to accommodate variety of tasks often performed by the user. One of such tasks is the ability to clean the working area in an efficient manner.

The present invention contemplates provision of such a workstation, allowing the user to conduct a variety of operations at a site distant from the source of AC power and clean the work area afterwards.

### SUMMARY OF THE INVENTION

It is, therefore, an object of the present invention to provide a workstation for delivering electrical power to a job site located a distance from the conventional source of electrical power.

It is another object of the present invention to provide a workstation that is easily transportable to a job site.

It is a further object of the present invention to provide a workstation that provides a cleaning device within the workstation to allow the user to efficiently clean the work area upon demand.

These and other objects of the present invention are achieved through a provision of a hollow cabinet or enclosure that is formed by a front wall, two side walls, a rear wall and an upper portion provided with a top work plate. The front wall of the cabinet has one or more sliding drawers and a pair of hinged door. A main compartment of the cabinet is enclosed by the hinged doors. An optional wet/dry vacuum cleaner can be positioned in the main compartment behind the hinged doors.

A front socket plate is positioned in the front of the cabinet above the hinged doors. The socket plate carries one or more front socket units that allow electrical connection of work tools or equipment to the cabinet at a remote job site. The front socket plate carries an on/off switch to regulate the supply of electricity to the front socket units. A light member mounted on the front socket plate signals availability of electric power in the front socket units. A rear socket plate secured on the rear wall of the enclosure carries one or more rear electrical socket units, which serve as additional connections for the tools to the source of electrical power. The rear socket plate, similar to the front socket plate, carries an on/off switch to regulate the supply of electricity to the front socket units. A light member mounted on the socket plate allows the user to visually determine whether the electric power is available in the rear socket units.

Mounted inside the main compartment are a pair of reel assemblies, each of which has a reel for holding a length of an electrical extension cord. One end of one of the cords extends through an opening in the front wall, while the one end of the second cord extends through an opening in the rear wall of the cabinet. The reel assemblies are rotationally suspended from support assemblies secured to a transverse plate mounted in the main compartment.

The cabinet is supported by a pair of recessed rotating wheels mounted in the bottom rear corners of the cabinet. A handle secured on the rear wall of the cabinet allows a user to tilt the cabinet backward, lifting the front of the enclosure off the ground and push or pull the cabinet on the wheels to a desired job site. A battery may be positioned inside the cabinet to provide a source of DC power.

The upper portion of the enclosure is provided with a hinged lid that, when lifted, allows access to an upper compartment. The upper compartment may be used for storing additional small tools, nails, glue guns, etc. often required at ajob site.

### BRIEF DESCRIPTION OF THE DRAWINGS

Reference will now be made to the drawings, wherein like parts are designated by like numerals, and wherein

FIG. 1 is a perspective view of the workstation in accordance with the present invention.

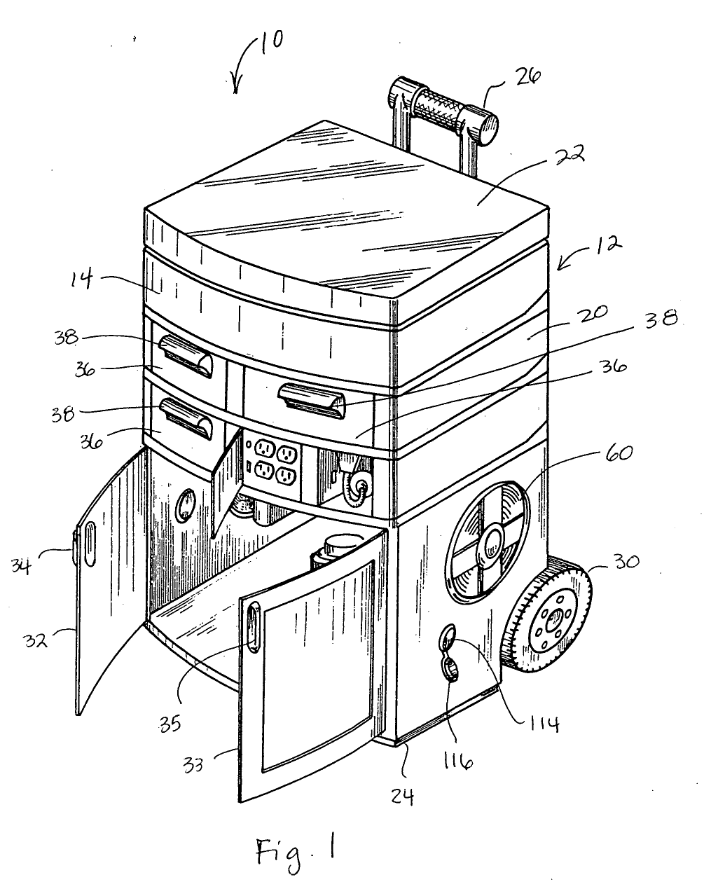

FIG. 2 is a perspective view of the workstation of the present invention, with the top cover in an open position.

FIG. 3 is a detail view of a reel-housing compartment of the workstation of the present invention.

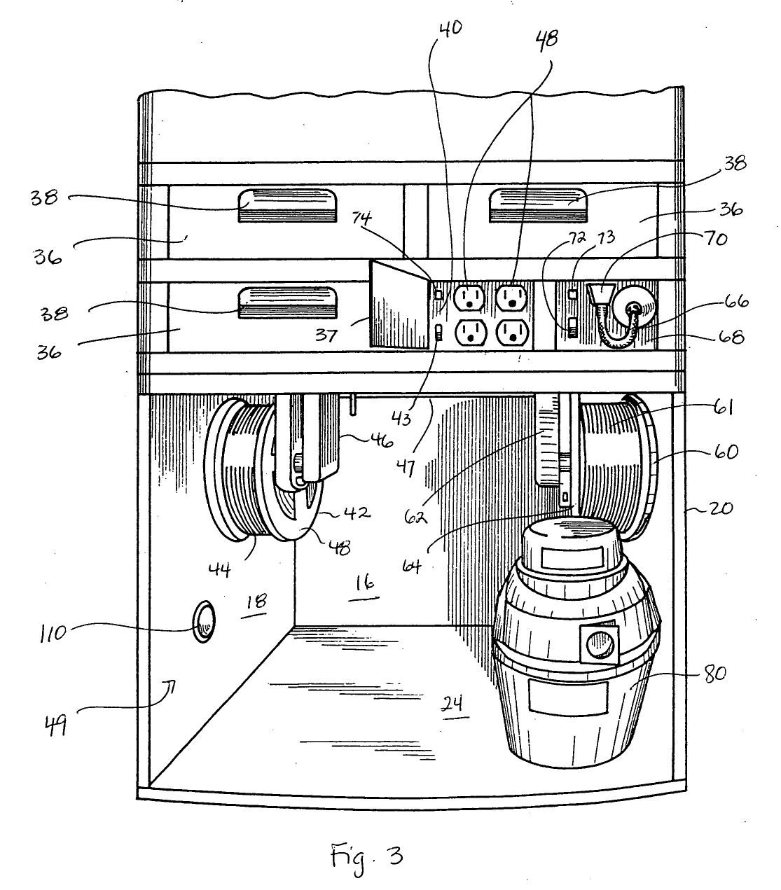

FIG. 4 is a side view of the workstation.

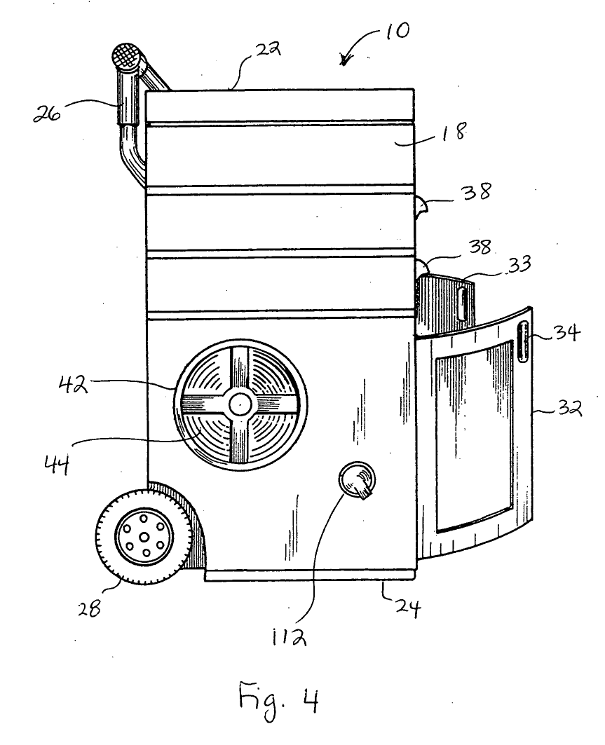

FIG. 5 is a back view of the workstation.

FIG. 6 is a perspective rear view of the workstation.

### DETAIL DESCRIPTION OF THE PREFERRED EMBODIMENT

Turning now to the drawings in more detail, numeral 10 designates the workstation in accordance with the present invention. The workstation 10 comprises a hollow cabinet-like enclosure 12 having a front wall 14, a rear wall 16, a first sidewall 18, a second sidewall 20, and a top work plate 22. The height of the cabinet 12 is selected to approximate the height of other workstations and workbench products.

The cabinet 12 is supported by a pair of recessed rotating wheels 28, 30 mounted at the rear bottom corners of the cabinet 12. When the cabinet 12 is stationary, the bottom 24 of the cabinet 12 rests on the horizontal surface, for instance, the floor of a workshop or the ground at a work site. When the cabinet 12 needs to be repositioned, the cabinet 12 is tilted backwards, lifting the front of the cabinet 12 off the ground by using a handle assembly 26. The cabinet can then be pushed or pulled using the supporting rotating wheels 28 and 30, to the desired location.

The front wall 14 of the cabinet 12 is provided with a pair of hinged doors 32, 33 with respective handles 34, 35 to allow access to the interior of the hollow cabinet 12. One or more sliding drawers 36 are mounted in an upper part of the front wall 14. A pull knob 38 allows easy pulling of the respective drawers 36 and access to the interior of the drawers (now shown) when necessary. Small items, such as pliers, tape, wire, nails, bolts, and other items may be stored in the drawers 36, as necessary.

A first socket plate 40 is mounted on the front wall 14 above the hinged doors 32, 33. The socket plate 40 can carry one or more front electrical socket units 41, such as 110-volt sockets, for connection of the electrically-powered equipment, when required. A cord (not shown) extending through the cabinet delivers AC power to the sockets 41, thereby allowing the user to connect any necessary equipment directly to the cabinet 12 at a remote site.

An on/off switch 43 allows the user to terminate electric connection to the sockets 41. A light member 74 allows the user to visually ascertain whether the sockets are provided with electric power. For instance, the light member may be lit green to signal that the socket units 41 can be used for connecting power tools and equipment. A hinged door 37 covers the sockets 41 and the socket plate 40 when the door 37 is closed.

The first sidewall 18 carries the first electrical cord reel 42 adapted to receive a length of the cord 44 wound thereon. A support assembly 46 is secured to a reel plate 48 to allow winding and unwinding of the cord 44 upon demand. The support assembly 46 is suspended from a transverse plate 47 mounted in the compartment 49 enclosed by the doors 32, 33.

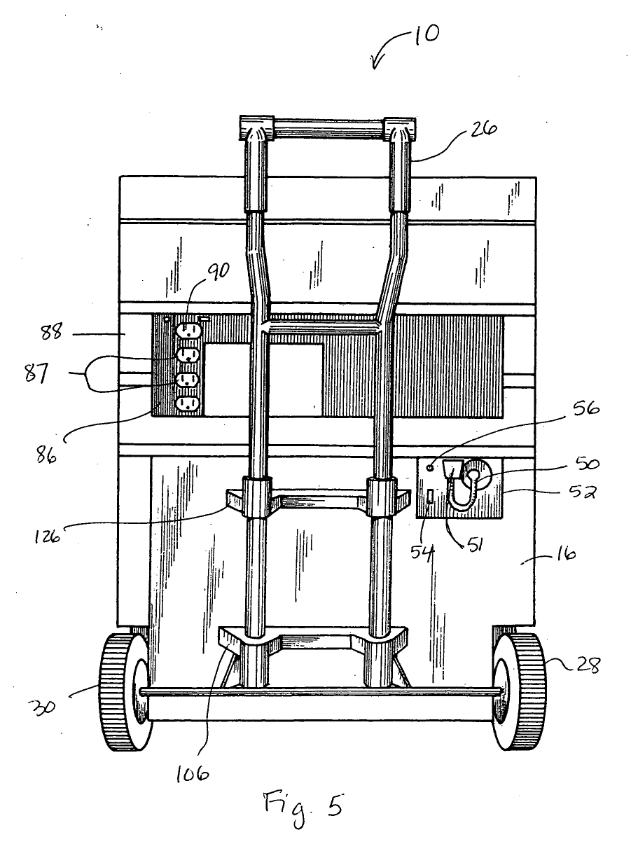

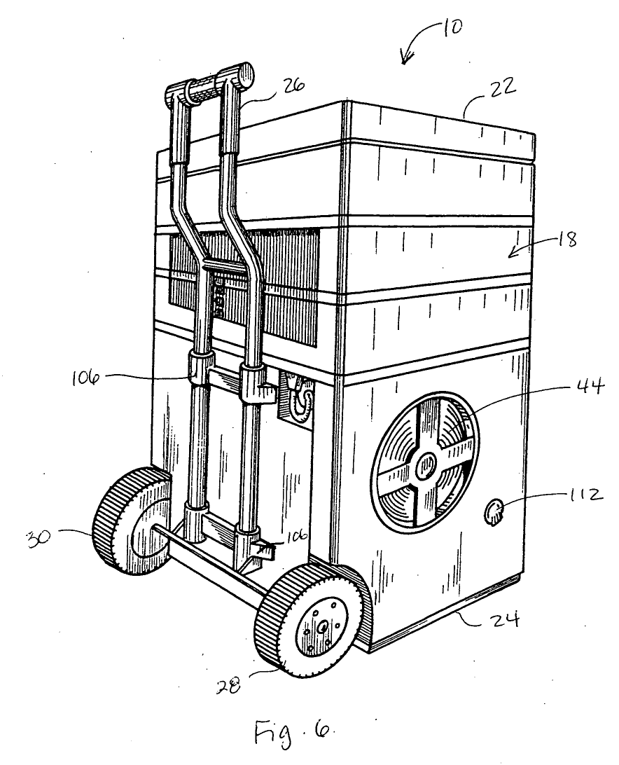

The majority of the reel 42 is positioned inside the compartment 49. A connection end 50 of the cord 44 extends through an opening 52 in the back wall 16 of the hollow cabinet 12 (FIGS. 5 and 6). The end 50 carries a socket assembly 51, which a user can grab and pull, unwinding the cord 44 to the desired extension. The user can then connect an electric tool to the socket 51 and work with the tool a distance from the cabinet 12. An on/off switch 54 is provided adjacent the end 50 of the cord 44 for regulating the supply of power to the cord 44.

A signal light 56 positioned above the switch 54 plate allows the user to ascertain whether the power is supplied to the extension cord socket 51. If desired, the light may be illuminated green when the electrical power is available in the cord 44.

A second reel 60 is mounted on the second sidewall 20 within the compartment 49 and is supported by a second reel support assembly 62. A reel plate 64 is secured to the support assembly 62, which is suspended from the transverse plate 47. The second reel 60 carries a length of electric cord 61 wound thereon. A connection end 66 of the second reel cord 6 extends from the compartment 49 into a compartment 68 formed in the front of the cabinet 12 above the compartment 49.

An extension cord socket 70 of the second reel cord 61 is positioned in the compartment 68 making the second reel 60 suitable for connection to an electrically-powered tool or appliance. An on/off switch 72 regulates the supply of power to the second reel 60. A signal light 73 allows the user to visually ascertain whether the electricity is supplied to the cord 61.

An optional dry/wet vacuum 80 can be positioned in the compartment 49, resting on the bottom 24 of the cabinet 12. The vacuum 80 allows the user to clean the work area after the job has been completed. The cabinet 12 can be supplied to a user without the vacuum 80, if desired.

A second, rear socket plate 86 is mounted in a middle portion 88 of the back wall 16. Of course, other suitable locations on the rear wall 16 can be selected for securing the socket plate 86. The second socket plate 86 can carry one or more rear electrical socket units 87, such as 110-volt sockets, for connection of the electrically-powered equipment, when required. A cord (not shown) extending through the cabinet 12 delivers AC power to the sockets 87, thereby allowing the user to connect any necessary equipment directly to the back of the cabinet 12 at a remote site.

An on/off switch 90 allows the user to terminate electric connection to the sockets 87. A light member, similar to the light member 74, can be provided adjacent the switch 90 to allow the user to visually ascertain whether the electric power is available in the socket units 87. If desired, the light can be illuminated green or other desired color when the electricity is available in the rear socket units 87.

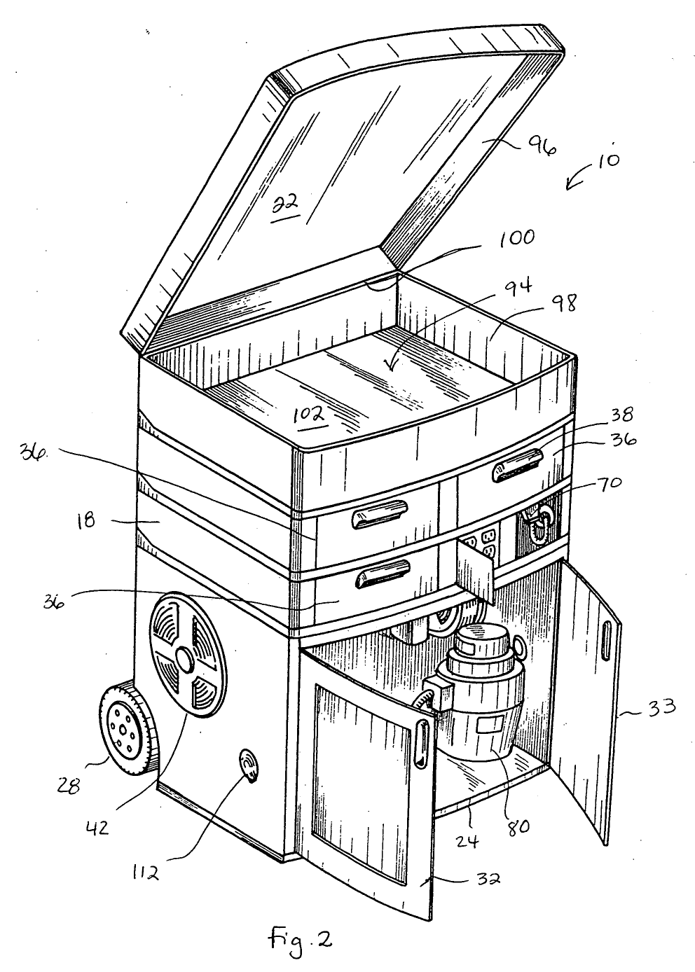

As can be seen in FIG. 2, the top of the cabinet 12 forms a top compartment 94 closed off by the top plate 22 and a peripheral lip 96. A part of the lip 96 is hingedly secured to an upright peripheral wall 98 along a hinge line 100. When the plate 22 is lifted, the user obtains access to the compartment 94, which can be sued for storage of hand tools and small equipment that are transported to the job site in the cabinet 12. The bottom the compartment 94 is formed by a horizontal plate 102, which forms a top of the compartment receiving drawers 36.

Secured to the rear wall 18 are spaced handle retainers 106 that secured the U-shaped handle 26 to the cabinet 12. The handle retainers 106 secure the bottom and middle portions of the handle 26. The handle 26 allows the user to tilt the cabinet 12 and push it or pull it, while the cabinet 12 is supported by the wheels 28 and 30.

The top plate 22 of the cabinet 12 forms a work surface on which the user can perform various tasks, while the compartment 94 can be used for holding small tools and equipment. The size of the top plate 22 can be selected to closely accommodate the dimensions of the cabinet 12. Alternatively, the top plate 22 can be made interchangeable, allowing larger plates to be positioned on top of the cabinet 12 to form a larger work surface.

An opening 110 is formed in the sidewall 18. A hinged cap 112 selectively closes the opening 110 from an exterior of the wall 18. A similar opening 114 is formed in the wall 20, and a hinged cap 116 selectively closes the opening 114 from the exterior of the wall 20. The openings 110 and 114 can be used for extension of cords, cables and the like from and into the cabinet 12.

In operation, the user connects one or both of the cords 44, 61 to a municipal power supply. The user then moves the cabinet 12 to the desired distance and connects other equipment to the extension cord other end.

The workstation 10 can be manufactured from wood or metal. An optional source of direct current may be provided inside the cabinet 12. A rechargeable battery may be placed inside the cabinet 12; the battery (not shown) may be used for recharging electrically powered equipment. The DC power source can be 6-18 volts, depending on the user's s choice. The reels for the extension cords can accommodate various lengths of cords and can be made bigger, if desired, to accommodate a particularly long cord.

Many changes and modifications can be made in the design of the present invention without departing from the spirit thereof. I therefore pray that my rights to the present invention be limited only by the scope of the appended claims.

I claim:

1. A portable workstation for delivering electrical power supply to a remote job site, said workstation comprising:
a hollow cabinet enclosure having a main compartment defined by a front wall, a rear wall, a first side wall, a second side wall, a bottom plate and an upper portion;
a pair of recessed rotating wheels secured to rear bottom corners of the enclosure;
at least one sliding drawer mounted in an upper part of the enclosure;
a pair of hinged doors located below said at least one sliding drawer on the front wall of the enclosure for providing access to the main compartment;
a first reel assembly mounted inside the main compartment and secured by the first side wall, said first reel assembly being adapted for holding a length of a first electrical extension cord wound thereon, said first electrical extension cord extending through the rear wall of the enclosure; and
a second reel assembly mounted inside the main compartment and secured by the second side wall, said second reel assembly being adapted for holding a length of a second electrical extension cord wound thereon, said second electrical extension cord extending through the front wall of the enclosure.

2. The workstation of claim 1, further comprising at least one front electrical socket unit mounted above said pair of hinged drawers, said at least one socket unit being electrically connectable to an electrical power supply.

3. The workstation of claim 2, wherein said at least one front electrical socket unit is provided with an on/off switch.

4. The workstation of claim 3, wherein said at least one front electrical socket unit is further provided with a light member adapted to signal status of electrical connection of said at least one front electrical socket unit with an electrical power source.

5. The workstation of claim 1, further comprising at least one rear electrical socket unit mounted on the rear wall of the enclosure, said at least one rear electrical socket unit being electrically connectable to an electrical power supply.

6. The workstation of claim 5, wherein said at least one rear electrical socket unit is provided with an on/off switch.

7. The workstation of claim 6, wherein said at least one rear electrical socket unit is further provided with a light member adapted to signal status of electrical connection of said at least one rear electrical socket unit with an electrical power source.

8. The workstation of claim 1, further comprising a handle for moving said enclosure to a desired job site.

9. The workstation of claim 8, wherein said handle is secured to the rear wall of the enclosure by a plurality of securing members.

10. The workstation of claim 9, wherein said securing members secure a lower part and a middle part of the handle.

11. The workstation of claim 8, wherein said handle has a generally U-shaped configuration and extends upwardly above the upper portion of the enclosure.

12. The workstation of claim 1, wherein said upper portion comprises a top plate carrying a downwardly extending peripheral lip.

13. The workstation of claim 12, wherein the enclosure is provided with a top edge and wherein said lip is hingedly secured to the top edge.

14. The workstation of claim 12, further comprising an upper plate mounted below said top edge, and wherein an upper compartment is defined between said top plate and said upper plate.

15. The workstation of claim 1, wherein each of said first reel assembly and said second reel assembly are rotationally suspended from a transverse plate mounted in the main compartment by a respective support assembly.

16. A workstation for carrying electrical connections to a remote job site, the workstation comprising:
a hollow cabinet enclosure having a main compartment defined by a front wall, a rear wall, a first side wall, a second side wall, a bottom plate and an upper portion defining a separate upper compartment;
a pair of recessed rotating wheels secured to rear bottom corners of the enclosure;
at least one sliding drawer mounted in an upper part of the enclosure;
a pair of hinged doors located below said at least one sliding drawer on the front wall of the enclosure for providing access to the main compartment;
a first reel assembly mounted inside the main compartment and secured by the first side wall, said first reel assembly being adapted for holding a length of a first electrical extension cord wound thereon, said first electrical extension cord extending through the rear wall of the enclosure; and
a second reel assembly mounted inside the main compartment and secured by the second side wall, said second reel assembly being adapted for holding a length of a second electrical extension cord wound thereon, said second electrical extension cord extending through the front wall of the enclosure, said first reel and said second reel being rotationally suspended inside the main compartment.

17. The workstation of claim 15, further comprising a front socket plate carrying a plurality of front electrical socket units mounted above said pair of hinged drawers, said front socket units being electrically connectable to an electrical power supply.

18. The workstation of claim 17, wherein said front socket plate carries an on/off switch for regulating supply of power to said plurality of front electrical socket units, and a light member for signaling status of electrical connection of the front electrical socket units to the electrical power supply.

19. The workstation of claim 15, further comprising a rear socket plate carrying a plurality of rear electrical socket units mounted on the rear wall of the enclosure, said rear socket units being electrically connectable to an electrical power supply.

20. The workstation of claim 19, wherein said rear socket plate carries an on/off switch for regulating supply of power to said plurality of rear electrical socket units, and a light member for signaling status of electrical connection of the rear electrical socket units to the electrical power supply.

21. The workstation of claim 16, further comprising a generally U-shaped handle for moving said enclosure to a desired job site, said handle having an upper part extending above the upper portion of the enclosure.

22. The workstation of claim 21, wherein said handle is secured to the rear wall of the enclosure by a plurality of securing members, said securing members securing a lower part and a middle part of the handle to the rear wall of the enclosure.

23. The workstation of claim 16, wherein said upper portion comprises a top plate carrying a downwardly extending peripheral lip, wherein the enclosure is provided with a top edge, and wherein said lip is hingedly secured to the top edge.

24. The workstation of claim 23, further comprising an upper plate mounted below said top edge, and wherein an upper compartment is defined between said top plate and said upper plate.
